(19) United States
(12) Patent Application Publication
(10) Pub. No.: US 2018/0359050 A1
(43) Pub. Date: Dec. 13, 2018

(54) ADAPTIVE NETWORK CODING IN WIRELESS COMMUNICATIONS

(71) Applicant: NOKIA SOLUTIONS AND NETWORKS OY, Espoo (FI)

(72) Inventors: Mads Lauridsen, Aalborg Øst (DK); Frank Frederiksen, Klarup (DK)

(21) Appl. No.: 15/778,815

(22) PCT Filed: Nov. 25, 2015
(86) PCT No.: PCT/EP2015/077698

§ 371 Date: May 24, 2018

(51) Int. Cl. H04L 1/00; H04L 1/18

(52) U.S. Cl. CPC H04L 1/0011; H04L 1/1825; H04L 1/1812

(57) ABSTRACT

A first network node (eNB) is configured to receive (404), from a second network node (UE), channel performance indicator values regarding a serving cell, and estimate (404) a number of network-coded packets based on the received channel performance indicator values, such that the estimated number of network-coded packets defines a number of network-coded packets required by the second network node for successful detection of payload data. The second network node is configured to generate (402) the value of a channel performance indicator regarding the serving cell, and cause (403) transmission of the generated value of the channel performance indicator to the first network node, wherein the generated value of the channel performance indicator directly or indirectly indicates the number of network-coded packets required by the second network node for successful reception of payload data that is an input to network coding.

### TECHNICAL FIELD

The invention relates to communications.

### BACKGROUND

In cellular wireless communication systems packet transmission/reception errors typically happen either due to erroneous channel information, changed channel conditions, or aggressive link adaptation, where a scheduling unit pushes the modulation and coding scheme used to the limit to obtain the maximum throughput possible. A hybrid automatic repeat request (HARQ) procedure is used in the cellular wireless communication systems to allow for high spectral efficiency, as HARQ provides protection against the packet transmission errors.

### BRIEF DESCRIPTION

According to an aspect, there is provided the subject matter of the independent claims. Embodiments are defined in the dependent claims.

One or more examples of implementations are set forth in more detail in the accompanying drawings and the description below. Other features will be apparent from the description and drawings, and from the claims.

### BRIEF DESCRIPTION OF DRAWINGS

In the following, the invention will be described in greater detail by means of preferred embodiments with reference to the accompanying drawings, in which

FIG. 1 illustrates a wireless communication system to which embodiments of the invention may be applied;

FIGS. 2 and 3 illustrate a HARQ procedure with combined BLER/CQI estimation and retransmission;

FIG. 4 illustrates a signalling diagram of a procedure for network coding according to an embodiment of the invention;

FIGS. 5 and 6 illustrate CPI estimation and data transfer using network coding according to an embodiment;

FIGS. 7 and 10 illustrate implementing network coding in parallel with a HARQ procedure;

FIGS. 8 and 9 illustrate processes for network coding according to some embodiments of the invention;

FIGS. 11 and 12 illustrate blocks diagrams of apparatuses according to some embodiments of the invention.

### DETAILED DESCRIPTION OF SOME EMBODIMENTS

The following embodiments are exemplary. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments. Furthermore, words “comprising” and “including” should be understood as not limiting the described embodiments to consist of only those features that have been mentioned and such embodiments may contain also features/structures that have not been specifically mentioned.

Embodiments described may be implemented in a radio system, such as in at least one of the following: universal mobile telecommunication system (UMTS, 3G) based on basic wideband-code division multiple access (W-CDMA), high-speed packet access (HSPA), long term evolution (LTE), LTE-advanced, and/or 5G system. The present embodiments are not, however, limited to these systems.

The embodiments are not, however, restricted to the system given as an example but a person skilled in the art may apply the solution to other communication systems provided with necessary properties. One example of a suitable communications system is the 5G system, as listed above. It is assumed that network architecture in 5G will be quite similar to that of the LTE-advanced. 5G is likely to use multiple input-multiple output (MIMO) antennas, many more base stations or nodes than the current network deployments of LTE (a so-called small cell concept), including macro sites operating in co-operation with smaller local area access nodes and perhaps also employing a variety of radio technologies for better coverage and enhanced data rates. 5G will likely be comprised of more than one radio access technology (RAT), each optimized for certain use cases and/or spectrum.

It should be appreciated that future networks will most probably utilize network functions virtualization (NFV) which is a network architecture concept that proposes virtualizing network node functions into “building blocks” or entities that may be operationally connected or linked together to provide services. A virtualized network function (VNF) may comprise one or more virtual machines running computer program codes using standard or general type servers instead of customized hardware. Cloud computing or cloud data storage may also be utilized. In radio communications this may mean node operations to be carried out, at least partly, in a server, host or node operationally coupled to a remote radio head. It is also possible that node operations will be distributed among a plurality of servers, nodes or hosts. It should also be understood that the distribution of labour between core network operations and base station operations may differ from that of the LTE or even be non-existent. Some other technology advancements probably to be used are software-defined networking (SDN), big data, and all-IP, which may change the way networks are being constructed and managed.

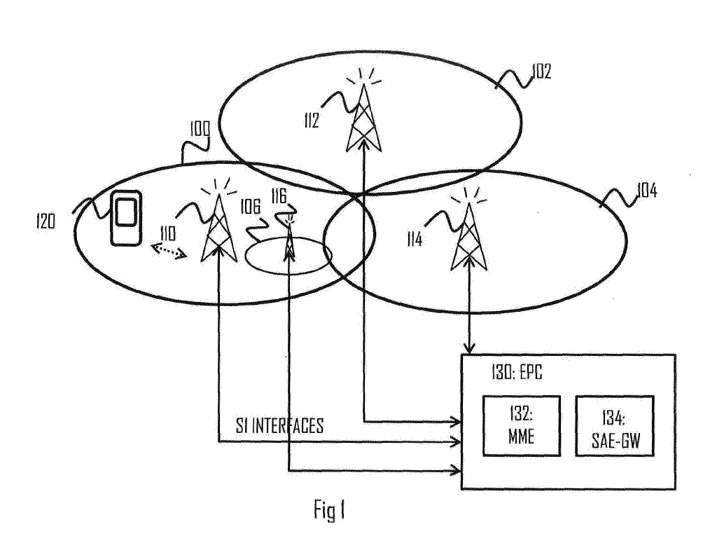

FIG. 1 illustrates an example of a cellular communication system to which embodiments of the invention may be applied. Cellular radio communication networks, such as the long term evolution (LTE), the LTE-advanced (LTE-A) of the 3rd generation partnership project (3GPP), or the predicted future 5G solutions, are typically composed of at least one network element, such as a network element 110, providing a cell 100. Each cell may be, e.g. a macro cell, a micro cell, femto, or a pico cell, for example. The network element 110 may be an evolved node-B (eNB) as in the LTE and LTE-A, or any other apparatus capable of controlling radio communication and managing radio resources within a cell. For 5G solutions, the implementation may be similar to LTE-A, as described above. The network element 110 may be called a base station or an access node. The cellular communication system may be composed of a radio access network of network elements 110, 112, 114, e.g. eNBs, each controlling a respective cell or cells 100, 102, 104. The network elements 110 to 114 may each control a macro cell 100 to 104 providing wide area coverage for terminal devices 120. The network elements 110 to 114 may also be called access nodes because they provide the terminal devices 120 with wireless access to other networks such as the internet. Additionally, one or more local area access nodes 116 may be arranged within a control area of a network element 110, 112, 114 controlling a macro cell, 100 to 104. The local area access node 116 may provide wireless access within a sub-cell 106 that may be comprised within a macro cell 100. Examples of the sub-cell may include a micro, pico and/or femto cell. Typically, the sub-cell provides a hot spot within a macro cell. The operation of the local area access node 116 may be controlled by a network element 110 under whose control area the sub-cell is provided. The network element 110 and the other network elements 112 to 116 may support dual connectivity (DC) in which the terminal device 120 has established multiple connections with cells associated with a master eNB network element and a secondary eNB network element.

The network element 110 may employ carrier aggregation in which the terminal device 112 is allocated with resources from a plurality of component carriers that may be on contiguous frequency bands or on non-contiguous frequency bands. One network element 110 may provide one component carrier, e.g. a primary component carrier, while another network element 116 may provide another component carrier, e.g. a secondary component carrier. The network element 110 operating the primary component carrier may carry out scheduling of resources on all component carriers, or each network element 110, 116 may control scheduling of the component carrier it operates. Alternatively network element 110 may provide one component carrier, e.g. a primary component carrier, as well as another component carrier, e.g. a secondary component carrier.

In the case of multiple eNBs in the communication network, the eNBs may be connected to each other with an X2 interface as specified in LTE. Other communication methods between the network elements may also be possible. The network elements 110 to 116 may be further connected via an S1 interface to an evolved packet core (EPC) 130, more specifically to a mobility management entity (MME) 132 and to a system architecture evolution gateway (SAE-GW) 134.

The radio system of FIG. 1 may support machine type communication (MTC). MTC may enable providing service for a large amount of MTC capable devices, such as the at least one terminal device 120. The at least one terminal device 120 may comprise mobile phones, smart phones, tablet computers, laptops and other devices used for user communication with the radio communication network, such as a MTC network. These devices may provide further functionality compared to the MTC scheme, such as communication link for voice, video and/or data transfer. However, in MTC perspective the at least one terminal device 120 may be understood as a MTC device. The at least one terminal device 120 may also comprise another MTC capable device, such as a sensor device providing position, acceleration and/or temperature information to name a few examples.

Transferring packets with a non-zero block error rate (BLER) target is optimal from a capacity/spectral efficiency perspective. Using the non-zero BLER results in packet reception errors which are usually handled by the receiver by requesting for a retransmission of the packet. However, there is both control overhead in terms of increased signalling, and delays involved in packet retransmissions. In addition, the receiver is often required to notify the transmitter that the receiver received the packet correctly as well, i.e. packet feedback in terms of a control loop is present and active independent of the current BLER. On top of this, the receiver typically also needs to implement a reordering buffer to ensure that the received packets are delivered to higher layers in a correct sequence.

In LTE, a BLER target is based on channel quality indicator (CQI) feedback which provides the highest modulation and coding scheme (MCS) index, which results in a BLER value below the given BLER target (in 3GPP, the BLER target is defined to be 10%, i.e. UE provides an MCS-related CQI, such that it guarantees that UE is able to receive data with 90% probability of success). CQI is based on the receiver monitoring reference signals sent by the transmitter. CQI may be estimated for the entire channel bandwidth and/or subsets of the channel bandwidth.

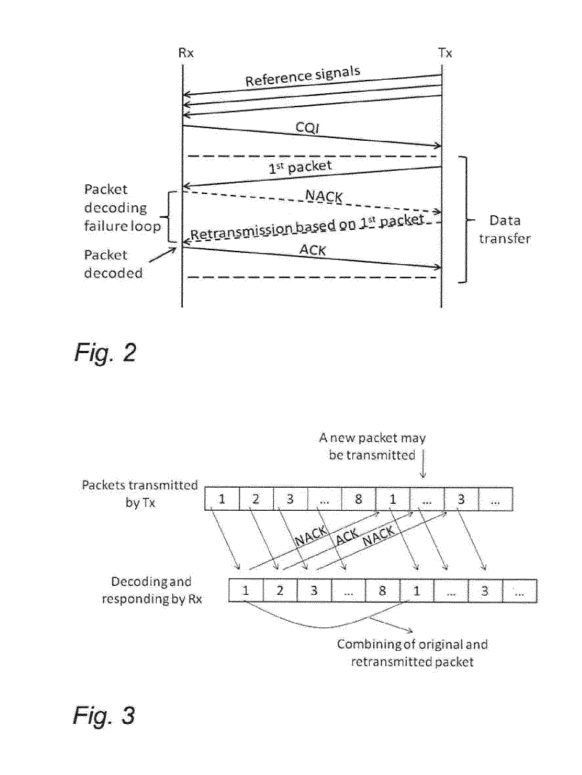

In LTE, the retransmissions are implemented using an N-channel stop-and-wait (SAW) HARQ procedure which entails the receiver responds with a negative acknowledgement (NACK) in case of packet error, after which the transmitter sends an updated packet. After correctly decoding the packet, the receiver sends an acknowledgement (ACK) which then terminates the HARQ procedure for that packet. To ensure efficiency, LTE applies 8 parallel SAW HARQ processes per receiver which therefore is to keep track of 8 processes and respond to them. This results in a relatively high control message overhead and delays, as each retransmission is to be scheduled individually. The combined BLER/CQI estimation and retransmission scheme in LTE is illustrated in FIG. 2.

The LTE HARQ procedure is further illustrated in FIG. 3, wherein the receiver is forced to buffer messages that the receiver has not been able to decode, in order to combine the messages with messages retransmitted later. The combining may be based on chase combining, wherein the original encoded message is retransmitted, or incremental redundancy, wherein the retransmitted message includes new but still redundant information. In incremental redundancy, the target is to improve the effective code rate of forward error correction used for the channel coding, while in chase combining, the target is to provide gains through coherent power combining. From information point of view, incremental redundancy is superior to chase combining. Each retransmission may only correspond to one previously sent packet. Whenever the receiver has successfully decoded a packet, the receiver is to respond with the ACK message to notify the transmitter.

A concept of network coding is based on coding principles that target transmitting “partial information” towards receiver nodes such that it is possible to recover full information with less dedicated transmissions. Network coding was primarily related to transmission of data through a network of transceiver nodes, where some of the communication links may be erroneous or even broken. Typically, network coding is based on coding across a number of packets to create a number of linear combinations derived from these. Some research has been made in terms of combining HARQ and network coding. An approach of using network coding in connection with HARQ over AWGN channels has been suggested, wherein the network coding may be able to provide gains of up to 0.5 dB.

Also “N-in-1 retransmission with network coding” has been proposed, wherein a “super-retransmission-packet” is created, carrying N retransmitted packets jointly within one radio transmission.

Further, it has been suggested to apply network coding on a user agent layer of WiMAX, wherein user application packets are network-coded to ensure near-errorless operation.

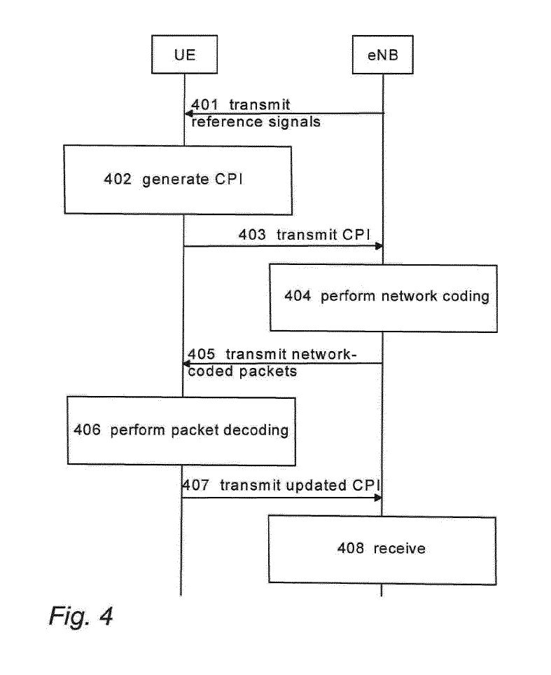

FIG. 4 illustrates an embodiment for retransmissionless network-coded data transfer between a terminal device 120 and network element of a cellular communication system, e.g. a network element 110.

Referring to FIG. 4, the network element, such as network element 110, causes (block 401) transmission of reference signals to the terminal device (such as terminal device 120). In block 402, the terminal device acquires and measures the reference signals transmitted from the network element. Based on the measurement, the terminal device performs (block 402) channel estimation to generate the value of the channel performance indicator (CPI) regarding the serving cell 100. In block 403, the terminal device causes transmission of the generated CPI value to the network element, regarding the serving cell 100. In block 404, the network element receives the generated CPI value from the terminal device, and calculates or estimates the required number of network-coded (or linearly coded or specially coded) packets for successful or reliable reception based on the generated CPI value. Further, in block 404, the network element performs network coding of payload packets received in the network element and directed to the terminal device, by generating a number of linear combinations of the payload packets. The number of network-coded packets defines the number of network-coded packets required by the terminal device for successful detection of payload data. The terminal device is to receive a minimum number of packets before being able to decode the payload packets. The network element is to combine/the terminal device is to decode an expected number of packets before the packet is reliably detected. The network element may transmit a maximum number of packets towards the terminal device. The number of packets entails the network element is to wait for the final packet to arrive in its buffer before the network element may generate the linear combinations. In block 405, the network element causes transmission of the network-coded packets to the terminal device (i.e. the network element performs data transfer in block 405). In block 406, the terminal device initiates and performs decoding of the network-coded packets when the terminal device has received a sufficient number of packets. Error detection mechanisms such as CRC (cyclic redundancy check) may be used for validating whether the packet was received correctly. Also, in case UE indicates a certain indicative number of needed packets (through CPI), UE may use this indicative number as a starting point (when knowing the payload size). In block 407, the terminal device may provide and transmit to the network element an updated CPI based on the most recent data transfer 405. However, the terminal device does not transmit an ACK to the network element when the packet has been successfully decoded. In block 408, the network element may receive the updated CPI from the terminal device. Based on the updated CPI the network element may check (block 408) whether the number of network-coded packets was too high/low, recalculate the number of packets based on the updated CPI value, and use the recalculated number of packets for performing network coding of payload packets. For example, an outer loop algorithm may be created for “learning from the past”. It may also be indicated to the scheduling node that more linear combinations are needed to successfully decode the packet(s).

Network coding relies on generating packets as a number of linear combinations of original packets, and then transferring the network-coded packets instead of the originals. If N packets are to be transferred, the receiver also receives at least N network-coded packets. In this way, each packet, like HARQ with incremental redundancy, provides new information about the original set of packets.

An embodiment relates to next generation of wireless systems such as future evolutions for LTE-advanced, or future generation of completely new wireless systems. An approach is taken to the combination of network coding and HARQ at lower network layers, that even replaces some of the traditional HARQ and ARQ schemes.

In an embodiment, a long term channel performance indicator (CPI) is used to determine the number of network-coded packets that result in a previously defined packet error rate (PER) at the receiver. Thus the use of HARQ and the related signalling of ACK/NACKs and retransmissions may be omitted, because the transmitter knows when it has transferred a sufficient number of packets to the receiver (based on the CPI).

In an embodiment, the receiver is able to estimate a longer term CPI, such that the transmitter may calculate how many linear combinations of packets the transmitter is to send. Alternatively, CPI includes information both on the recommended modulation and coding scheme and the number of linear combinations needed. CPI is thus similar to CQI, but CPI is based on a longer averaging window compared to CQI. Therefore a target is to have receivers with low mobility.

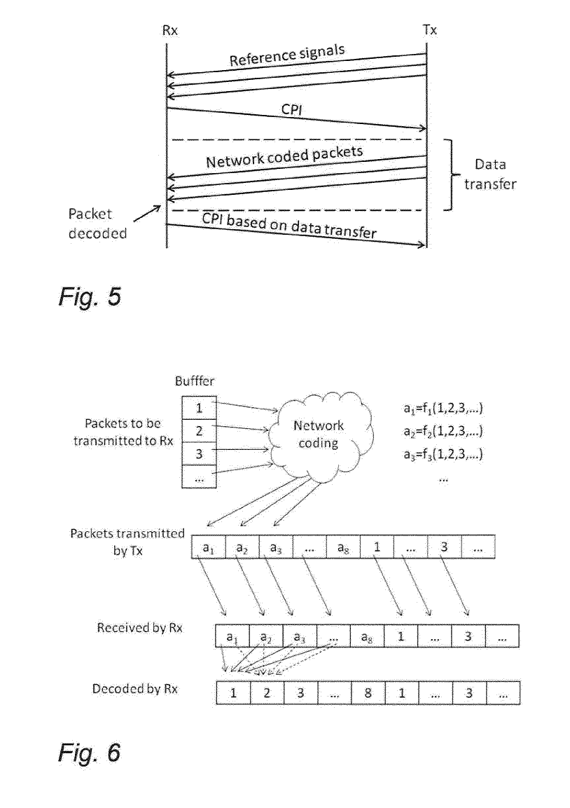

In an embodiment, the receiver (Rx, e.g. UE) is able to provide an updated CPI based on the most recent data transfer, but the receiver does not provide an ACK when the packet has been successfully decoded, as the transmitter (Tx, e.g. eNB) simply assumes that the transmitted network coded packets were sufficient for transferring the information content successfully to the receiver. In an embodiment, the updated CPI also helps the transmitter understand whether the number of network-coded packets was too high/low (forming the base for using outer loop adjustment according to the previous performance). FIG. 5 illustrates CPI estimation and data transfer using network-coding according to an embodiment.

FIG. 6 illustrates packet flow of the network-coded transfer according to an embodiment. When the transmitter has received the packets which are to be transferred to the receiver, the transmitter first performs network coding by generating linear combinations of a certain number of packets based on CPI. The number of network coded packets defines how many packets the receiver is to receive before the receiver may perform the decoding, and also entails the transmitter is to wait for the final packet to arrive in its buffer before the transmitter is able to generate the linear combinations. Therefore the network coding may also result in a delay, but on the contrary to the HARQ delay which varies depending on the number of retransmissions, the network-coded delay is known in advance when the transmitter has calculated the number of packets using CPI. The transmitter may transmit a maximum number of packets towards the receiver. The receiver is to receive a minimum number of packets before being able to decode the payload packets. The transmitter is to combine/the receiver is to decode an expected number of packets before the packet is reliably detected.

In an embodiment, if the receiver has been able to receive packets faster than expected, the receiver may simply stop the decoding procedure, while the transmit procedure most likely continues.

An embodiment may also be used to replace the retransmission loop on a radio link control layer, and thus be combined with HARQ on a physical layer. In current systems, we have two layers of protection. The HARQ at MAC layer and RLC ARQ where it is possible to do selective retransmissions. In this example embodiment, we are simply suggesting to replace the RLC ARQ with the network coding (as this would be an alternative way of implementing “retransmission-less operation”.

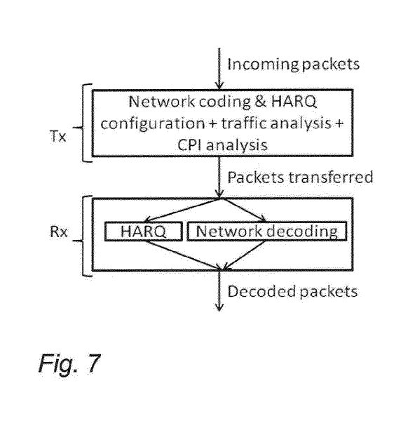

In an embodiment, it is also possible to implement both network coding and HARQ in both transmitter and receiver, and then select the most suitable technology depending on the current channel and traffic conditions as well as UE mobility conditions. FIG. 7 illustrates using either HARQ or network coding. Thus, the network coding procedure may be implemented in addition to the hybrid automatic repeat request procedure, wherein the network coding procedure may be activated and the hybrid automatic repeat request procedure may be deactivated, or vice versa, depending on the current channel and traffic conditions as well as the UE mobility conditions.

The feature of not confirming packet reception using ACK/NACK may also be implemented by the use of a very low MCS index, but the advantage of using network coding as compared to the use of a very low MCS index is that, if network coding is used, the receiver is able to combine the received network-coded packets to obtain multiple of the original packets.

In terms of processing delays, the introduction of network coding may introduce a longer delay as more packets are to be available for generating the linear combinations needed for the network coded transmission. However, there are network coding techniques, where it is possible to gradually increase the number of packets, and thereby start the algorithm with just a few packets for generating the linear combinations. As the packets being combined are most likely already available in the transmitter side buffers, the data is for some cases already available for processing. However, this allows for disabling the N-channel SAW HARQ which introduces a retransmission delay whenever a packet error is seen.

In an embodiment, when the lower layer HARQ operation is replaced by the network coding, the very tight feedback cycle is no longer required. Thus In an embodiment, the need for establishing low delay feedback channels may be reduced in future 5G systems.

In an embodiment, in addition to downlink, the network decoding as described above may also be implemented in uplink, wherein the transmitter (Tx, 110) is the terminal device, and the receiver (Rx, 120) is the network element (e.g. LTE base station), in FIG. 5.

Thus, network coding may be utilized for replacing or combining with HARQ in wireless communication.

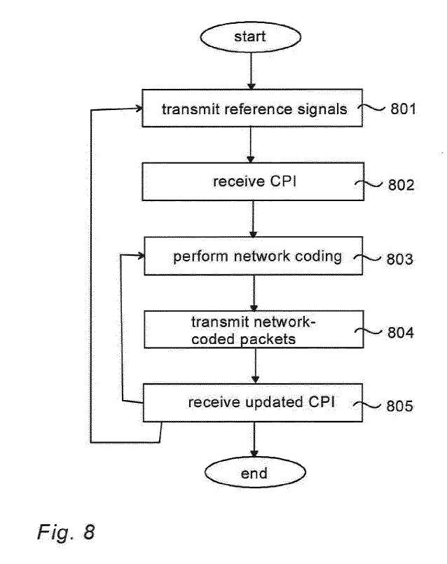

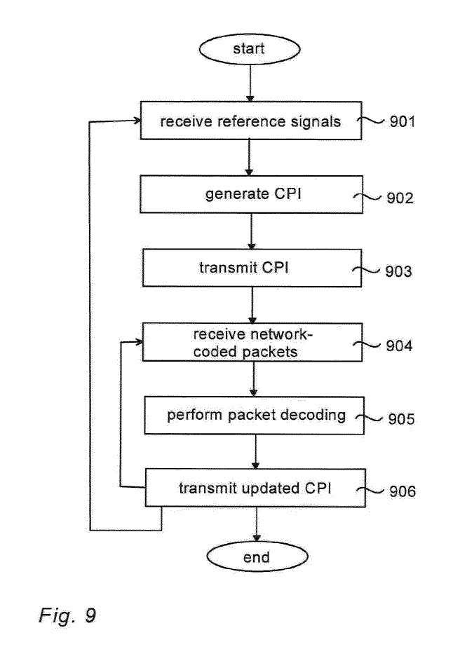

FIGS. 8 and 9 illustrate exemplary processes for downlink network coding between a terminal device 120 and network element of a cellular communication system, e.g. a network element 110. However, an embodiment is also applicable to uplink network coding.

Referring to FIG. 8, the network element, such as network element 110, causes (block 801) transmission of reference signals towards the terminal device (such as terminal device 120). In block 802, the network element receives a channel performance indicator value from the terminal device, and calculates or estimates a number of network-coded packets based on the received CPI value. In block 803, the network element performs network coding of payload packets received in the network element and directed to the terminal device, by generating linear combinations of the payload packets. The number of network-coded packets defines the number of network-coded packets required by the terminal device for successful detection of payload data. The number of packets also entails the network element is to wait for the final packet to arrive in its buffer before the network element may generate the linear combinations. In block 804, the network element causes transmission of the network-coded packets to the terminal device (i.e. the network element performs data transfer in block 804). In block 805, the network element may receive an updated CPI (updated based on the most recent data transfer 804) from the terminal device. However, the terminal device does not need to transmit an ACK to the network element when a packet has been successfully decoded. Based on the updated CPI, the network element may check (block 805) whether the number of network coded packets was too high/low, recalculate the number of packets based on the updated CPI value, and use the recalculated number of packets for performing network coding (in block 803) of packets.

Referring to FIG. 9 the terminal device acquires and measures (block 901) reference signals transmitted from the network element via a wireless communications link. Based on the measurement, the terminal device performs (block 902) channel estimation to generate the value of the channel performance indicator (CPI) regarding the serving cell 100. In block 903, the terminal device causes transmission of the generated CPI value to the network element, regarding the serving cell 100. The generated value of the channel performance indicator directly or indirectly indicates the number of network-coded packets required by the terminal device for successful reception of payload data that is an input to network coding. In block 904, the terminal device receives network-coded packets from the network element (i.e. the terminal receives transferred data in block 904) and initiates and performs (block 905) decoding of the network-coded packets. In block 906, the terminal device may provide and transmit to the network element an updated CPI based on the most recent data transfer 904. However, the terminal device does not need to transmit an ACK to the network element when a packet has been successfully decoded. New reference signals may be received (in block 901) from the network element, or new network-coded packets may be received (block 904) based on the updated CPI.

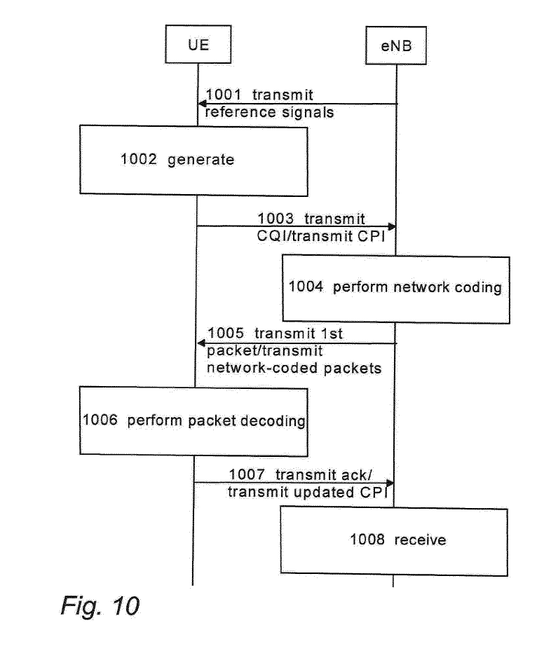

FIG. 10 illustrates an embodiment for data transfer between a terminal device 120 and network element of a cellular communication system, e.g. a network element 110, wherein both the HARQ procedure and the retransmissionless network-coding procedure may be implemented (see also FIG. 7).

Referring to FIG. 10, the network element, such as network element 110, causes (block 1001) transmission of reference signals to the terminal device (such as terminal device 120). In block 1002, the terminal device acquires and measures the reference signals transmitted from the network element. Based on the measurement, the terminal device performs (block 1002) channel estimation to generate the value of the channel performance indicator (CPI) regarding the serving cell 100. In block 1002, the terminal device also obtains a channel quality indicator CQI value. In block 1003, the terminal device causes transmission of the generated CPI value to the network element, regarding the serving cell 100. In block 1003, the terminal device also causes transmission of the obtained CQI value to the network element, regarding the serving cell 100. In block 1004, the network element receives the generated CPI value from the terminal device, calculates a number of network-coded packets based on the estimated CPI value, and performs network coding of payload packets received in the network element and directed to the terminal device, by generating linear combinations of the payload packets. The number of network-coded packets defines a number of network-coded packets required by the terminal device for successful detection of payload data. The number of packets also entails the network element is to wait for the final packet to arrive in its buffer before the network element may generate the linear combinations. In block 1004, the network element also receives the CQI value, and performs a traffic analysis based on the received CQI. In block 1005, if the NC procedure is selected, the network element causes transmission of the network-coded packets to the terminal device. Alternatively, in block 1005, if the HARQ procedure is selected, the network element causes transmission of the first packet to the terminal device. In block 1006, if NC was selected, the terminal device initiates and performs decoding of the network-coded packets when the terminal device has received a sufficient number of packets. Alternatively, in block 1006, if HARQ was selected, the terminal device receives the 1st packet. In block 1007, the terminal device may provide and transmit to the network element an updated CPI based on the most recent data transfer 1005. Alternatively, in block 1007, if HARQ was selected, the terminal device transmits an ACK to the network if the 1st packet was correctly received in the terminal device (or NACK if not, wherein the network element is to perform retransmission). In block 1008, the network element may receive the updated CPI, or the network element receives the ACK (or NACK) from the terminal device. The decision whether to apply HARQ or network coding may be made in a scheduling node (or some other control node in the network). The decision may be based e.g. on service requirements, service class, radio conditions, cell load conditions, etc.

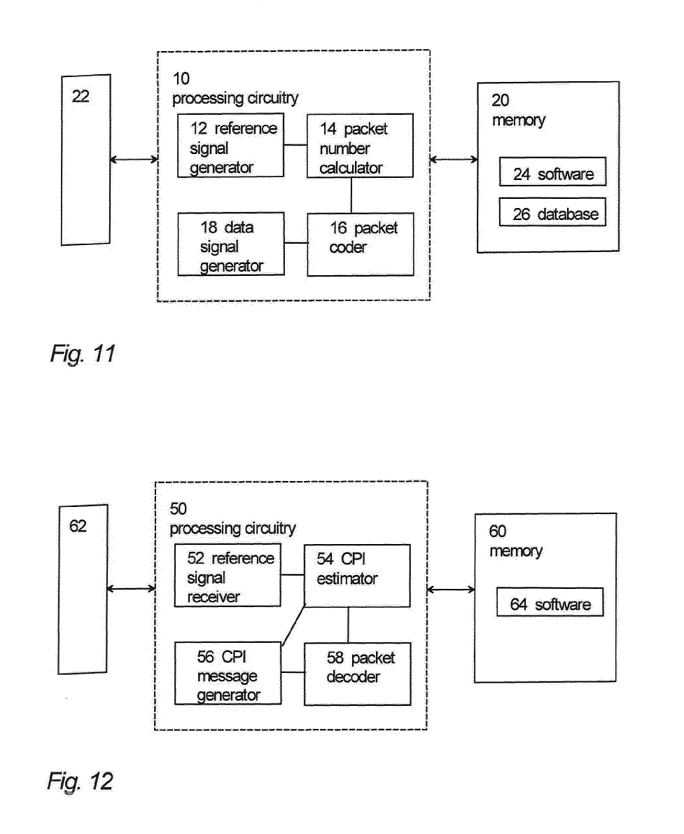

An embodiment provides an apparatus comprising at least one processor and at least one memory including a computer program code, wherein the at least one memory and the computer program code are configured, with the at least one processor, to cause the apparatus to carry out the procedures of the above-described network element or network node (first network node). The at least one processor, the at least one memory, and the computer program code may thus be considered as an embodiment of means for executing the above-described procedures of the network element or the network node. FIG. 11 illustrates a block diagram of a structure of such an apparatus. The apparatus may be comprised in the network element or in the network node, e.g. the apparatus may form a chipset or a circuitry in the network element or in the network node. In some embodiments, the apparatus is the network element or the network node. The apparatus comprises a processing circuitry 10 comprising the at least one processor. The processing circuitry 10 may comprise a reference signal generator 12 configured to transmit reference signals towards a terminal device. The processing circuitry 10 may comprise a packet number calculator 14 configured to estimate a number of network-coded packets based on the estimated channel performance indicator value, such that the number of network-coded packets defines a number of network-coded packets required by the terminal device for successful detection of payload data. The processing circuitry 10 may comprise a packet coder 16 configured to perform network coding of received payload packets directed to the terminal device, by generating linear combinations of the payload packets. The packet coder 16 may be configured to perform the network coding, as described above, and output information on the coded packets to a data signal generator 18 configured to create and transmit data signalling to the terminal device, the data signalling comprising the network-coded packets.

The processing circuitry 10 may comprise the circuitries 12, 14, 16 and 18 as sub-circuitries, or they may be considered as computer program modules executed by the same physical processing circuitry. The memory 20 may store one or more computer program products 24 comprising program instructions that specify the operation of the circuitries 12 to 18. The memory 20 may further store a database 26 comprising definitions for downlink control channel signalling, for example. The apparatus may further comprise a radio interface 22 providing the apparatus with radio communication capability with the terminal devices. The radio interface may comprise a radio communication circuitry enabling wireless communications and comprise a radio frequency signal processing circuitry and a baseband signal processing circuitry. The baseband signal processing circuitry may be configured to carry out the functions of a transmitter and/or a receiver. In some embodiments, the radio interface may be connected to a remote radio head comprising at least an antenna and, in some embodiments, radio frequency signal processing in a remote location with respect to the base station. In such embodiments, the radio interface may carry out only some of radio frequency signal processing or no radio frequency signal processing at all. The connection between the radio interface and the remote radio head may be an analogue connection or a digital connection. In some embodiments, the radio interface may comprise a fixed communication circuitry enabling wired communications.

An embodiment provides an apparatus comprising at least one processor and at least one memory including a computer program code, wherein the at least one memory and the computer program code are configured, with the at least one processor, to cause the apparatus to carry out the procedures of the above-described terminal device. The at least one processor, the at least one memory, and the computer program code may thus be considered as an embodiment of means for executing the above-described procedures of the terminal device (or second network node). FIG. 12 illustrates a block diagram of a structure of such an apparatus. The apparatus may be comprised in the terminal device, e.g. the apparatus may form a chipset or a circuitry in terminal device. In some embodiments, the apparatus is the terminal device. The apparatus comprises a processing circuitry 50 comprising the at least one processor. The processing circuitry 50 may comprise reference signal receiver 52 configured to acquire a reference signal transmitted from the network element. A CPI estimator 54 is configured to perform channel estimation to generate a CPI value. The generated value of the channel performance indicator directly or indirectly indicates a number of network-coded packets required by the terminal device for successful reception of payload data that is an input to network coding. The CPI estimator 54 may be configured to perform the channel estimation, as described above, and output information on the CPI value to a CPI message generator 56 configured to create and transmit a CPI message (including the generated CPI) to the network element. A packet decoder 54 is configured to decode network-coded packets received from the network element.

The processing circuitry 50 may comprise the circuitries 52, 54, 56 and 58 as sub-circuitries, or they may be considered as computer program modules executed by the same physical processing circuitry. The memory 60 may store one or more computer program products 64 comprising program instructions that specify the operation of the circuitries 52 to 58. The apparatus may further comprise a radio interface 62 providing the apparatus with radio communication capability with the terminal devices. The radio interface may comprise a radio communication circuitry enabling wireless communications and comprise a radio frequency signal processing circuitry and a baseband signal processing circuitry. The baseband signal processing circuitry may be configured to carry out the functions of a transmitter and/or a receiver. In some embodiments, the radio interface may be connected to a remote radio head comprising at least an antenna and, in some embodiments, radio frequency signal processing in a remote location with respect to the base station. In such embodiments, the radio interface may carry out only some of radio frequency signal processing or no radio frequency signal processing at all. The connection between the radio interface and the remote radio head may be an analogue connection or a digital connection. In some embodiments, the radio interface may comprise a fixed communication circuitry enabling wired communications.

As used in this application, the term ‘circuitry’ refers to all of the following: (a) hardware-only circuit implementations such as implementations in only analog and/or digital circuitry; (b) combinations of circuits and software and/or firmware, such as (as applicable): (i) a combination of processor(s) or processor cores; or (ii) portions of processor(s)/software including digital signal processor(s), software, and at least one memory that work together to cause an apparatus to perform specific functions; and (c) circuits, such as a microprocessor(s) or a portion of a microprocessor(s), that require software or firmware for operation, even if the software or firmware is not physically present.

This definition of ‘circuitry’ applies to all uses of this term in this application. As a further example, as used in this application, the term “circuitry” would also cover an implementation of merely a processor (or multiple processors) or portion of a processor, e.g. one core of a multi-core processor, and its (or their) accompanying software and/or firmware. The term “circuitry” would also cover, for example and if applicable to the particular element, a baseband integrated circuit, an application-specific integrated circuit (ASIC), and/or a field-programmable grid array (FPGA) circuit for the apparatus according to an embodiment of the invention.

The processes or methods described above in connection with FIGS. 1 to 12 may also be carried out in the form of one or more computer process defined by one or more computer programs. The computer program shall be considered to encompass also a module of a computer programs, e.g. the above-described processes may be carried out as a program module of a larger algorithm or a computer process. The computer program(s) may be in source code form, object code form, or in some intermediate form, and it may be stored in a carrier, which may be any entity or device capable of carrying the program. Such carriers include transitory and/or non-transitory computer media, e.g. a record medium, computer memory, read-only memory, electrical carrier signal, telecommunications signal, and software distribution package. Depending on the processing power needed, the computer program may be executed in a single electronic digital processing unit or it may be distributed amongst a number of processing units.

The present invention is applicable to cellular or mobile communication systems defined above but also to other suitable communication systems. The protocols used, the specifications of cellular communication systems, their network elements, and terminal devices develop rapidly. Such development may require extra changes to the described embodiments. Therefore, all words and expressions should be interpreted broadly and they are intended to illustrate, not to restrict, the embodiment.

It will be obvious to a person skilled in the art that, as the technology advances, the inventive concept can be implemented in various ways. The invention and its embodiments are not limited to the examples described above but may vary within the scope of the claims.

List of Abbreviations

HARQ hybrid automatic repeat request

LTE long term evolution

ACK acknowledgement

CPI channel performance indicator

CQI channel quality indicator

BLER block error rate

PER packet error rate

Rx receiver

1. A method comprising:
receiving, in a first network node from a second network node, channel performance indicator values regarding a serving cell; and
estimating, in the first network node, a number of network-coded packets based on the received channel performance indicator values, such that the estimated number of network-coded packets defines a number of network-coded packets required by the second network node for successful detection of payload data.

2. A method comprising:
generating, in a second network node, a value of a channel performance indicator regarding a serving cell; and
causing, in the second network node, transmission of the generated value of the channel performance indicator to a first network node,
wherein the generated value of the channel performance indicator directly or indirectly indicates the number of network-coded packets required by the second network node for successful reception of payload data that is an input to network coding.

3. A method according to claim 2, wherein the method comprises:
receiving, in the second network node from the first network node, a number of network-coded packets obtained by generating linear combinations of payload packets; and
performing, in the second network node, decoding of the received network-coded packets.

4. A method according to claim 1, wherein the method comprises:
performing, in the first network node, network coding of payload packets received in the first network node and directed to the second network node, by generating linear combinations of the payload packets; and
causing, in the first network node, transmission of a sequence of network-coded packets to the second network node, without knowing whether they arrive successfully at the second network node.

5. A method according to claim 2, wherein the method comprises:
causing, in the second network node, transmission of an updated value of channel performance indicator to the first network node, based on the received network-coded packets.

6. A method according to claim 1, wherein the method comprises:
receiving, in the first network node from the second network node, an updated value of the channel performance indicator;
based on the updated value of the channel performance indicator, re-determining, in the first network node, the number of the network-coded packets required by the second network node for successful detection of payload data; and
performing, in the first network node, network coding of packets based on the re-determined number of network-coded packets.

7. A method according to claim 1, wherein the method comprises:
generating, by the first network node, the linear combinations of the number of packets after receiving a final packet of the number of packets.

8. A method according to claim 2, wherein the method comprises:
discontinuing, by the second network node, the decoding of the network-coded packets, if a sufficient number of network-coded packets has been received faster than expected.

9. A method according to claim 1, wherein the channel performance indicator includes information on a longer term channel performance indicator, wherein the method comprises:
calculating, in the first network node, the number of packets based on the channel performance indicator.

10. A method according to claim 1, wherein the channel performance indicator includes information on a recommended modulation and coding scheme and a number of linear combinations required.

11. A method according to claim 1, wherein the method comprises:
implementing a network coding procedure in addition to a hybrid automatic repeat request procedure; and
activating the network coding procedure and deactivating the hybrid automatic repeat request procedure, or vice versa, depending on current channel and traffic conditions.

12. A method according to claim 1, wherein the first network node comprises a base station and the second network node comprises a terminal device, or vice versa.

13. An apparatus comprising
at least one processor; and
at least one memory including a computer program code, wherein the at least one memory and the computer program code are configured, with the at least one processor, to cause the apparatus to:
receive, from a second network node, channel performance indicator values regarding a serving cell; and
estimate a number of network-coded packets based on the received channel performance indicator values, such that the estimated number of network-coded packets defines a number of network-coded packets required by the second network node for successful detection of payload data.

14. (canceled)

15. An apparatus comprising
at least one processor; and
at least one memory including a computer program code, wherein the at least one memory and the computer program code are configured, with the at least one processor, to cause the apparatus to:
generate a value of a channel performance indicator regarding a serving cell; and
cause transmission of the generated value of the channel performance indicator to a first network node,
wherein the generated value of the channel performance indicator directly or indirectly indicates a number of network-coded packets required for successful reception of payload data that is an input to network coding.

16.-17. (canceled)

18. A computer program product embodied on a non-transitory distribution medium readable by a computer and comprising program instructions which, when loaded into the computer, execute a computer process comprising causing a network node to perform the method of claim 1.
